(19) United States
(12) Patent Application Publication
(10) Pub. No.: US 2025/0120796 A1
(43) Pub. Date: Apr. 17, 2025

(54) BOX ASSEMBLY

(71) Applicant: ShenZhen YUTO Packaging Technology Co., Ltd., Shenzhen (CN)

(72) Inventors: Zhiyong DING, Shenzhen (CN); Zongsheng YE, Shenzhen (CN)

(73) Assignee: ShenZhen YUTO Packaging Technology Co., Ltd., Shenzhen (CN)

(21) Appl. No.: 18/991,712

(22) Filed: Dec. 23, 2024

(30) Foreign Application Priority Data
Sep. 27, 2024 (CN) 202411368479.4

(51) Int. Cl. A61C 15/04

(52) U.S. Cl. CPC A61C 15/043

(57) ABSTRACT

The present application relates to a box assembly. The box assembly includes a paper bottom outer box, a paper inner holder, a paper floss bobbin, a paper upper holder, a floss cutter, and a paper top cover. The paper bottom outer box includes a first accommodating cavity. The paper inner holder includes a second accommodating cavity. The paper inner holder is arranged in the first accommodating cavity. The paper inner holder is detachably connected to the paper bottom outer box by friction fit only. The paper floss bobbin is rotatably connected to the paper inner holder. The paper upper holder has an outlet opening. The outlet opening is in communication with the second accommodating cavity. The paper upper holder is detachably connected to the paper inner holder by friction fit. The paper upper holder is for opening or closing the second opening.

### CROSS-REFERENCES TO RELATED APPLICATIONS

The present application claims priority to Chinese Patent Application No. 202411368479.4 filed on Sep. 27, 2024, which is incorporated herein by reference in its entirety.

### FIELD

The present application relates to the field of containers, in particular to a box assembly.

### BACKGROUND

A floss box is a small box assembly that can be used for holding a floss roll. The floss box can keep the floss roll clean. A user can conveniently carry the floss box. When the floss is used, a predetermined length (such as 25 centimeters or 33 centimeters) of floss is drew from the floss box. Then the floss is supported by fingers to clean teeth.

### SUMMARY

Embodiments of the present application provide a box assembly, including a paper bottom outer box, a paper inner holder, a paper floss bobbin, a paper upper holder, a floss cutter, and a paper top cover.

The paper bottom outer box includes a first accommodating cavity with a first opening. The paper inner holder includes a second accommodating cavity with a second opening. The paper inner holder is arranged in the first accommodating cavity. The paper inner holder is detachably connected to the paper bottom outer box by friction fit only. The first opening is disposed corresponding to the second opening. The second accommodating cavity is for accommodating a floss roll. The paper floss bobbin is rotatably connected to the paper inner holder. The paper floss bobbin is for supporting the floss roll. The paper upper holder has an outlet opening. The outlet opening is in communication with the second accommodating cavity. The paper upper holder is detachably connected to the paper inner holder by friction fit only. The paper upper holder is for opening or closing the second opening. The floss cutter is arranged on the paper upper holder. The floss cutter is used for cutting a floss led out of the outlet opening. The paper top cover is connected to the paper bottom outer box and configured to be flipped relative to the paper bottom outer box to switch between an open position and a closed position, wherein the closed position, the paper top cover closes the first opening and forms an accommodating space with the paper bottom outer box. The paper top cover is connected to the paper upper holder by friction fit only, and wherein the open position, the paper cover opens the first opening. The outlet opening and the floss cutter are exposed.

The box assembly in embodiments of the present application includes the paper bottom outer box, the paper inner holder, the paper floss bobbin, the floss cutter, and the paper top cover. The paper bottom outer box and the paper inner holder form a double-layer structure, and the overall structure formed by the paper bottom outer box and the paper inner holder has relatively high strength and pressure resistance, also has a clean characteristic after the floss roll is installed, and is less prone to deformation and crushing. The paper bottom outer box is detachably connected to the paper inner holder by friction fit, which facilitates the disassembly and assembly between the paper bottom outer box and the paper inner holder, reduces the difficulties of disassembly and assembly operations, and improves the convenience of use. The paper upper holder is connected to the paper inner holder, and the paper inner holder is connected to the paper bottom outer box, which facilitate mutual support of the paper upper holder, the paper inner holder, and the paper bottom outer box and ensure that the overall structure formed by the paper upper holder, the paper inner holder, and the paper bottom outer box has relatively high strength and pressure resistance and is less prone to deformation and crushing. The paper upper holder is detachably connected to the paper inner holder by friction fit, which facilitates the disassembly and assembly between the paper upper holder and the paper inner holder, reduces the difficulties of disassembly and assembly operations, and improves the convenience of use. The paper top cover and the paper bottom outer box form the accommodating space. The paper top cover and the paper bottom outer box jointly protect the paper inner holder, the paper floss bobbin, the paper upper holder, and the floss cutter, to reduce the possibility of contaminating the paper inner holder, the paper floss bobbin, the paper upper holder, and the floss cutter. In the box assembly of embodiments of the present application, the paper bottom outer box, the paper inner holder, the paper floss bobbin, the paper upper holder, and the paper top cover are all made of paper, which has good environmental friendliness, makes the discarded box assembly less likely to pollute the environment, and can be recycled to meet environmental requirements.

In some embodiments, the paper inner holder includes a body and an outer flange. The body is provided with the second accommodating cavity, and the outer flange and at least a portion of the body are separately connected to the paper bottom outer box by friction fit only.

In some embodiments, the paper inner holder includes two first sidewalls. Two ends of the paper floss bobbin are rotatably connected to the two first sidewalls. The first sidewalls each include a reinforcement portion. The reinforcement portion is connected to the paper bottom outer box by friction fit only.

In some embodiments, a portion of the first sidewall protrudes towards the paper bottom outer box to form the reinforcement portion. The reinforcement portion is located at the side of the paper floss bobbin close to the second opening.

In some embodiments, the paper inner holder includes two first sidewalls. The first sidewalls each are provided with a mounting hole. An end of the paper floss bobbin is inserted into the mounting hole. The end of the paper floss bobbin is rotatably connected to the first sidewall by friction fit only.

In some embodiments, a portion of the first sidewall protrudes towards the paper bottom outer box to form a protrusion. The protrusion is provided with the mounting hole. There is a gap between the protrusion and the paper bottom outer box. There is a gap between the end of the paper floss bobbin and the paper bottom outer box.

In some embodiments, the paper inner holder includes two first sidewalls and a second sidewall. The second sidewall connects the two first sidewalls. The first sidewalls and the second sidewall encloses the second accommodating cavity. At least a portion of the second sidewall is connected to the paper bottom outer box by friction fit only.

In some embodiments, the paper upper holder includes a third sidewall and a first top wall connected to each other. The third sidewall and the first top wall enclose a third accommodating cavity. The outlet opening and the floss cutter are disposed on the first top wall. The outlet opening is in communication with the third accommodating cavity. The second accommodating cavity is in communication with the third accommodating cavity. At least a portion of the third sidewall is inserted into the second accommodating cavity. The third sidewall is detachably connected to the paper inner holder by friction fit only.

In some embodiments, a portion of the third sidewall is detachably connected to the paper bottom outer box by friction fit only.

In some embodiments, the first top wall has a recess. The outlet opening and the floss cutter are arranged on two sides of the recess respectively.

In some embodiments, the paper top cover includes a fourth sidewall and a second top wall. The box assembly includes a paper connector, and the fourth sidewall is connected to the paper bottom outer box by the paper connector.

In some embodiments, an avoidance slope is provided on the side of the first top wall away from the paper connector. When the paper top cover is flipped relative to the paper bottom outer box, the avoidance slope is for avoiding the fourth sidewall.

In some embodiments, the paper upper holder has an avoidance opening. The floss cutter includes a first clamping piece, a connecting piece, a second clamping piece, and a cutting blade. The connecting piece connects the first clamping piece and the second clamping piece. The connecting piece is disposed to penetrate the avoidance opening. The floss cutter is clamped onto the paper upper holder by the first clamping piece and the second clamping piece. The first clamping piece is located on an outer side of the paper upper holder, and the second clamping piece is located on an inner side of the paper upper holder. The cutting blade is arranged on the first clamping piece.

In some embodiments, at least one of the paper bottom outer box, the paper inner holder, the paper floss bobbin, the paper upper holder, and the paper top cover is formed by curing raw materials including bamboo pulp and bagasse pulp. A total mass of the bamboo pulp accounts for 35% of the raw materials. A total mass of the bagasse pulp accounts for 65% of the raw materials.

### BRIEF DESCRIPTION OF THE DRAWINGS

Exemplary embodiments of the present application will be described below with reference to the accompanying drawings.

FIG. 1 is a schematic structural view of a box assembly according to an embodiment of the present application;

FIG. 2 is a partial structural view of the box assembly according to an embodiment of the present application;

FIG. 3 is a partially exploded structural view of the box assembly according to an embodiment of the present application;

FIG. 4 is a partially exploded structural view of the box assembly containing a floss roll according to an embodiment of the present application;

FIG. 5 is a partial structural view of a paper inner holder according to an embodiment of the present application;

FIG. 6 is a partial structural view of a paper upper holder according to an embodiment of the present application;

FIG. 7 is a schematic structural view of the box assembly according to an embodiment of the present application;

FIG. 8 is a partially exploded structural view of the paper upper holder and a floss cutter according to an embodiment of the present application; and

FIG. 9 is a partial cross-sectional structural view of the box assembly according to an embodiment of the present application.

In the drawings, the same reference numerals are used for the same components. The drawings are not drawn to actual scale.

### LIST OF REFERENCE SIGNS

10. Box assembly;
20. Paper bottom outer box; 21. First accommodating cavity;
30. Paper inner holder; 301. Second accommodating cavity; 31. Body; 311. First sidewall; 311a. Reinforcement portion; 311b. Mounting hole; 311c. Protrusion; 312. Second sidewall; 32. Outer flange;
40. Paper floss bobbin;
50. Paper upper holder; 501. Outlet opening; 502. Floss fixing portion; 503. Avoidance opening; 504. Third accommodating cavity; 51. Third sidewall; 52. First top wall; 521. Recess; 522. Avoidance slope;
60. Floss cutter; 61. First clamping piece; 62. Connecting piece; 63. Second clamping piece; 64. Cutting blade;
70. Paper top cover; 701. Fourth accommodating cavity; 71. Fourth sidewall; 72. Second top wall;
80. Paper connector;
100. Side;
200. Bottom;
300. Floss roll.

### DETAILED DESCRIPTION OF THE DISCLOSURE

Embodiments of the present application will be further described in detail below in conjunction with the accompanying drawings and embodiments. The detailed description of the following embodiments and the accompanying drawings are used for illustrating the principle of the present application, but cannot be used for limiting the scope of the present application, that is, the present application is not limited to the described embodiments.

In the description of the present application, it should be noted that, unless otherwise specified, “plurality of” means two or more; the orientations or positional relationships indicated by the terms “upper”, “lower”, “left”, “right”, “inner”, “outer”, etc. are only for facilitating description of the present application and simplifying the description, but do not indicate or imply that the pointed apparatuses or elements must have specific orientations or be constructed and operated in specific orientations. Therefore, the terms should not be understood to limit the present application. In addition, the terms “first”, “second”, “third”, and the like are for descriptive purposes only and should not be understood as indicating or implying relative importance. “Vertical” does not require being strictly vertical, but allows for an allowable range of error. “Parallel” does not require being strictly parallel, but allow for an allowable range of error.

The “embodiment” mentioned in the present application means that specific features, structures or characteristics described in conjunction with the embodiment may be included in at least one embodiment of the present application. The phrase appearing at various places in the description does not necessarily refer to the same embodiment, or an independent or alternative embodiment exclusive of other embodiments. An embodiment described in the present application may be combined with other embodiments.

The orientation terms appearing in the following description all indicate directions shown in the drawings, and are not intended to limit specific structures of the present application. In the description of the present application, it should be noted that, unless otherwise specified and defined, the terms “mounted”, “connected”, and “connection” should be understood in a broad sense, In one embodiment, the “connection” may be fixed connected, detachable connection, integral connection, direct connection, or indirect connection by a medium. The specific meanings of the above terms in the present application according to specific circumstances.

Embodiments of the present application provide a box assembly, which has environmental friendliness and can replace existing plastic box assemblies by clever structural design. The entire box assembly in embodiments of the present application has strong structural strength and pressure resistance. Therefore, the box assembly in embodiments of the present application is less prone to deformation, crushing, and other problems during daily repeated use. The box assembly in embodiments of the present application is made of an environment-friendly material, making it less likely to pollute the environment after being discarded.

In order to better understand the present application, the box assembly in embodiments of the present application will be described below in conjunction with the accompanying drawings.

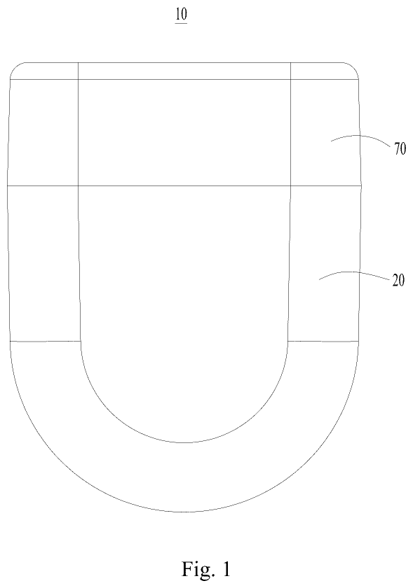

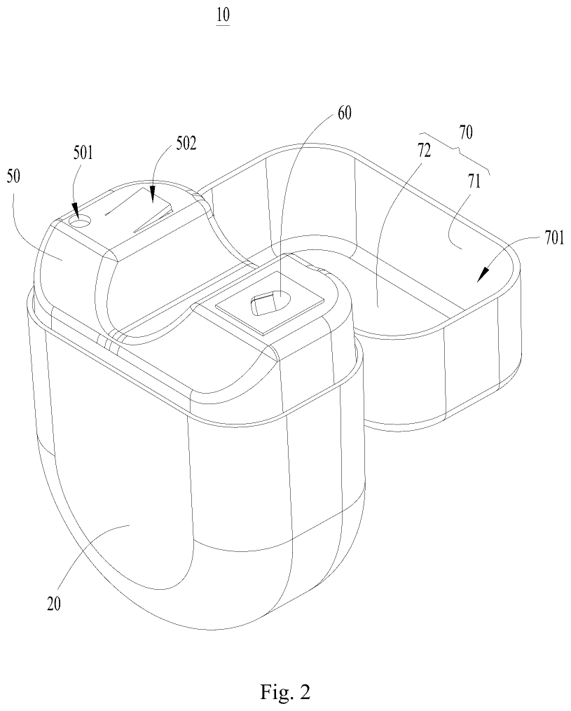

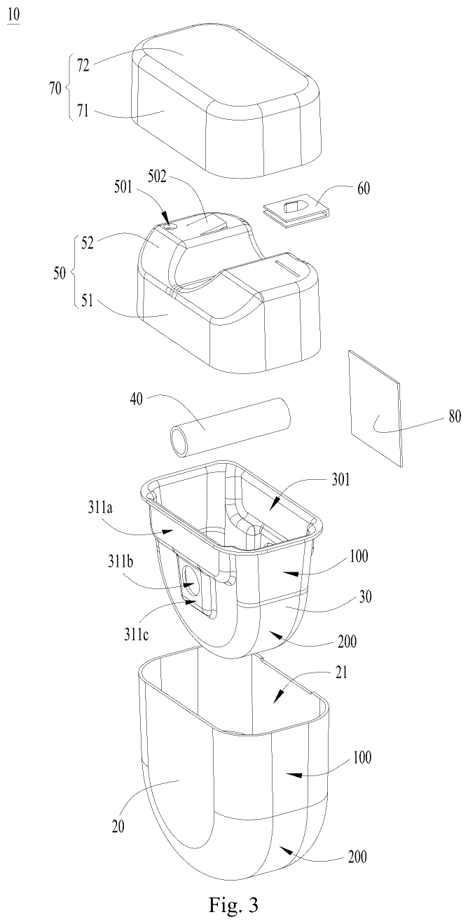

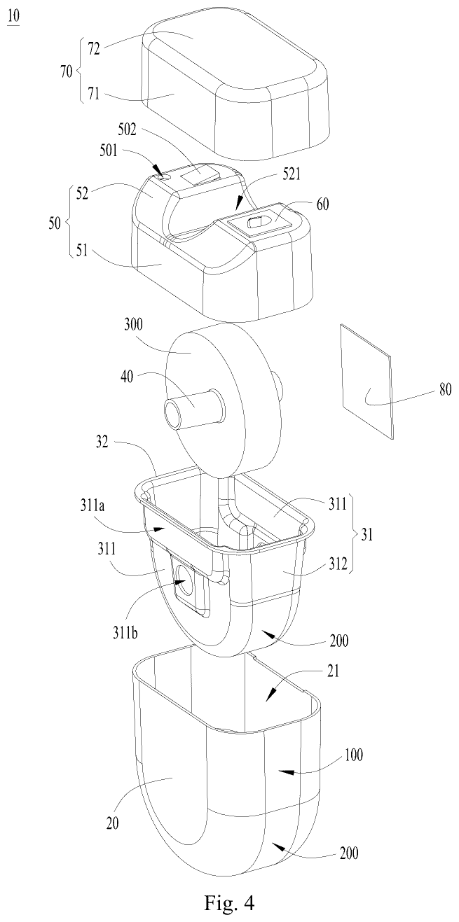

FIG. 1 illustrates a structure of a box assembly 10. FIG. 2 illustrates a partial structure of the box assembly 10. FIG. 3 illustrates a partially exploded structure of the box assembly 10. FIG. 4 illustrates a partially exploded structure of the box assembly 10 containing a floss roll 300.

As shown in FIG. 1 to FIG. 4, embodiments of the present application provide a box assembly 10, which includes a paper bottom outer box 20, a paper inner holder 30, a paper floss bobbin 40, a paper upper holder 50, a floss cutter 60, and a paper top cover 70.

The paper bottom outer box 20 includes a first accommodating cavity 21 with a first opening. The paper inner holder 30 includes a second accommodating cavity 301 with a second opening. The paper inner holder 30 is disposed in the first accommodating cavity 21. The paper inner holder 30 is detachably connected to the paper bottom outer box 20 by friction fit. The first opening is disposed corresponding to the second opening. The second accommodating cavity 301 is used for accommodating a floss roll 300.

The paper floss bobbin 40 is rotatably connected to the paper inner holder 30. The paper floss bobbin 40 is used for supporting the floss roll 300. The paper upper holder 50 has an outlet opening 501. The outlet opening 501 is in communication with the second accommodating cavity 301. The paper upper holder 50 is detachably connected to the paper inner holder 30 by friction fit. The paper upper holder 50 is used for opening or closing the second opening. The floss cutter 60 is disposed on the paper upper holder 50. The floss cutter 60 is used for cutting a floss led out of the outlet opening 501.

The paper top cover 70 is connected to the paper bottom outer box 20. The paper top cover 70 is flipped relative to the paper bottom outer box 20 to switch between an open position and a closed position. In the closed position, the paper top cover 70 closes the first opening and forms an accommodating space with the paper bottom outer box 20. The paper top cover 70 is connected to the paper upper holder 50 by friction fit, and the paper top cover 70 is disposed on the paper upper holder 50. In the open position, the paper top cover 70 opens the first opening. The paper upper holder 50 and the floss cutter 60 are exposed.

In embodiments of the present application, the box assembly 10 may be used by a user as follows: the user holds the paper bottom outer box 20 with fingers and opens the paper top cover 70; the user pinches with his or her fingers the floss led out of the outlet opening 501 of the paper upper holder 50, and then pulls the floss to draw a predetermined length (such as 25 centimeters or 33 centimeters) of floss; the user places and cuts the floss at the floss cutter 60, closes the paper top cover 70, and places the box assembly 10 down; the user can shape and support the floss with fingers, and the fingers guide the floss to clean teeth. After cleaning, the floss is discarded. The floss may be a nylon thread, a silk thread, or a polyester thread.

After the floss roll 300 inside the box assembly 10 is used up, the paper top cover 70 can be flipped to the open position, the paper upper holder 50 is separated from the paper inner holder 30 and is taken away. Then, the paper inner holder 30 is removed from the paper bottom outer box 20. The paper inner holder 30 and the paper floss bobbin 40 can be removed from the paper bottom outer box 20 by pulling the paper floss bobbin 40. The paper floss bobbin 40 is removed from the paper inner holder 30. A new floss roll 300 is reinstalled in the second accommodating cavity 301 of the paper inner holder 30. Next, the paper floss bobbin 40 is reinstalled on the paper inner holder 30. The paper floss bobbin 40 can be inserted into a central insertion hole of the floss roll 300. The paper inner holder 30, the paper floss bobbin 40, and the floss roll are installed into the paper bottom outer box 20. An end of the floss roll 300 is threaded through the outlet opening 501 of the paper upper holder 50, and the paper upper holder 50 is closed. Finally, the paper top cover 70 is flipped to the closed position, and the box assembly 10 can continue to be reused. Therefore, in each embodiment of the present application, not only the material but also the usage is environment-friendly.

The paper inner holder 30 in embodiments of the present application is disposed in the first accommodating cavity 21 of the paper bottom outer box 20. The paper bottom outer box 20 is a box that is usually in contact with user's hands. The paper bottom outer box 20 can protect the paper inner holder 30, to prevent the user's fingers from touching the paper inner holder 30, to reduce the possibility of contaminating the paper inner holder 30 by bacteria or dirt carried by the fingers. The paper inner holder 30 is detachably connected to the paper bottom outer box 20 by friction fit. The friction fit belongs to interference fit.

When the paper inner holder 30 needs to be removed from the paper bottom outer box 20, a pull force needs to be applied to the paper inner holder 30 to overcome the frictional resistance between the paper inner holder 30 and the paper bottom outer box 20, to separate the paper inner holder 30 from the paper bottom outer box 20. When the paper inner holder 30 needs to be loaded into the paper bottom outer box 20, pressure needs to be applied to the paper inner holder 30 to overcome the frictional resistance between the paper inner holder 30 and the paper bottom outer box 20, to assemble the paper inner holder 30 and the paper bottom outer box 20.

The paper inner holder 30 is detachably connected to the paper bottom outer box 20 by friction fit only, so no additional connector is required between the paper inner holder 30 and the paper bottom outer box 20. On the one hand, the quantity of parts of the entire box assembly 10 can be reduced, and the assembly process can be simplified. On the other hand, the paper inner holder 30 and the paper bottom outer box 20 are easy to disassemble and assemble, which is conducive to reducing difficulties in reuse of the box assembly 10 and replacement of the floss roll 300 and improving the usability of the box assembly 10.

The paper floss bobbin 40 is used for supporting the floss roll 300. When the user pulls the floss through the outlet opening 501 of the paper upper holder 50, the floss roll 300 and the paper floss bobbin 40 rotate synchronously. The paper floss bobbin 40 rotates relative to the paper inner holder 30. The floss roll 300 has the central insertion hole. When the floss roll 300 is replaced, the paper floss bobbin 40 is inserted into the central insertion hole of the floss roll 300.

The paper upper holder 50 is detachably connected to the paper inner holder 30 by friction fit. When the paper upper holder 50 needs to be separated from the paper inner holder 30, a pull force needs to be applied to the paper upper holder 50 to overcome the frictional resistance between the paper upper holder 50 and the paper inner holder 30, to separate the paper upper holder 50 from the paper inner holder 30. When the paper upper holder 50 and the paper inner holder 30 are assembled and the paper upper holder 50 is fixed, pressure needs to be applied to the paper upper holder 50 to overcome the frictional resistance between the paper upper holder 50 and the paper inner holder 30, to assemble the paper upper holder 50 and the paper inner holder 30.

The paper upper holder 50 is detachably connected to the paper inner holder 30 by friction fit only, so no additional connector is required between the paper upper holder 50 and the paper inner holder 30. On the one hand, the quantity of parts of the entire box assembly 10 can be reduced, and the assembly process can be reduced. On the other hand, the paper upper holder 50 and the paper inner holder 30 are easy to disassemble and assemble, which is conducive to reducing difficulties in reuse of the box assembly 10 and replacement of the floss roll 300 and improving the usability of the box assembly 10.

The floss cutter 60 is disposed on the paper upper holder 50. The arrangement that the box assembly 10 is equipped with the floss cutter 60 enables the user to use the floss cutter 60 conveniently to cut the floss led out from the outlet opening 501. Therefore, the user does not need to carry an additional tool for cutting the floss, to improve the convenience of using the box assembly 10. In one embodiment, the material of the floss cutter 60 may include metal materials such as steel and iron.

The paper top cover 70 is connected to the paper bottom outer box 20. When the paper top cover 70 is opened, the paper top cover 70 does not need to be removed and placed in another area, which reduces the possibility of losing the paper top cover 70. Meanwhile, the paper top cover 70 can be opened or closed by flipping the paper top cover 70, which is conducive to improving the convenience of operating the paper top cover 70 and improving the usability of the box assembly 10.

When the paper top cover 70 is in the closed position, the paper top cover 70 covers the first opening of the paper bottom outer box 20 and forms the accommodating space with the paper bottom outer box 20. The paper inner holder 30, the paper floss bobbin 40, the paper upper holder 50, and the floss cutter 60 are all located in the accommodating space. The paper top cover 70 and the paper bottom outer box 20 jointly protect the paper inner holder 30, the paper floss bobbin 40, the paper upper holder 50, and the floss cutter 60, to reduce the possibility of contaminating the paper inner holder 30, the paper floss bobbin 40, the paper upper holder 50, and the floss cutter 60.

When the paper top cover 70 is in the open position, the paper top cover 70 opens the first opening of the paper bottom outer box 20. The outlet opening 501 of the paper upper holder 50 and the floss cutter 60 are exposed, making it easy for the user to pull and cut the floss.

The box assembly 10 in embodiments of the present application includes the paper bottom outer box 20, the paper inner holder 30, the paper floss bobbin 40, the floss cutter 60, and the paper top cover 70. The paper bottom outer box 20 and the paper inner holder 30 form a double-layer structure, and the overall structure formed by the paper bottom outer box 20 and the paper inner holder 30 has relatively high strength and pressure resistance, also has the above clean characteristic after the floss roll 300 is installed, and is less prone to deformation and crushing. The paper bottom outer box 20 is detachably connected to the paper inner holder 30 by friction fit, which facilitates the disassembly and assembly between the paper bottom outer box 20 and the paper inner holder 30, reduces the difficulties of disassembly and assembly operations, and improves the convenience of use. The paper upper holder 50 is connected to the paper inner holder 30, and the paper inner holder 30 is connected to the paper bottom outer box 20, which facilitate mutual support of the paper upper holder 50, the paper inner holder 30, and the paper bottom outer box 20 and ensure that the overall structure formed by the paper upper holder 50, the paper inner holder 30, and the paper bottom outer box 20 has relatively high strength and pressure resistance and is less prone to deformation and crushing. The paper upper holder 50 is detachably connected to the paper inner holder 30 by friction fit, which facilitates the disassembly and assembly between the paper upper holder 50 and the paper inner holder 30, reduces the difficulties of disassembly and assembly operations, and improves the convenience of use. The paper top cover 70 and the paper bottom outer box 20 form the accommodating space. The paper top cover 70 and the paper bottom outer box 20 jointly protect the paper inner holder 30, the paper floss bobbin 40, the paper upper holder 50, and the floss cutter 60, to reduce the possibility of contaminating the paper inner holder 30, the paper floss bobbin 40, the paper upper holder 50, and the floss cutter 60. In the box assembly 10 of embodiments of the present application, the paper bottom outer box 20, the paper inner holder 30, the paper floss bobbin 40, the paper upper holder 50, and the paper top cover 70 are all made of paper, which has good environmental friendliness, makes the discarded box assembly 10 less likely to pollute the environment, and can be recycled to meet environmental requirements.

In some embodiments, the paper bottom outer box 20, the paper inner holder 30, the paper floss bobbin 40, the paper upper holder 50, and the paper top cover 70 can all be manufactured using a pulp molding process.

In some embodiments, the frictional resistance between the paper inner holder 30 and the paper bottom outer box 20 is greater than that between the paper upper holder 50 and the paper inner holder 30. When the paper upper holder 50 needs to be separated from the paper inner holder 30, the pull force applied to the paper upper holder 50 can separate the paper upper holder 50 from the paper inner holder 30, but the pull force is less than the frictional resistance between the paper inner holder 30 and the paper bottom outer box 20, so the pull force will not separate the paper inner holder 30 from the paper bottom outer box 20, to reduce the possibility of separating the paper inner holder 30 from the paper bottom outer box 20 when separating the paper upper holder 50 from the paper inner holder 30.

In some embodiments, the frictional resistance between the paper upper holder 50 and the paper inner holder 30 is greater than that between the paper top cover 70 and the paper upper holder 50. When the paper top cover 70 needs to be flipped from the closed position to the open position, the force applied to the paper top cover 70 can separate the paper top cover 70 from the paper upper holder 50, but the force is less than the frictional resistance between the paper upper holder 50 and the paper inner holder 30, so the force will not separate the paper upper holder 50 from the paper inner holder 30, to reduce the possibility of separating the paper upper holder 50 from the paper inner holder 30 when flipping the paper top cover 70.

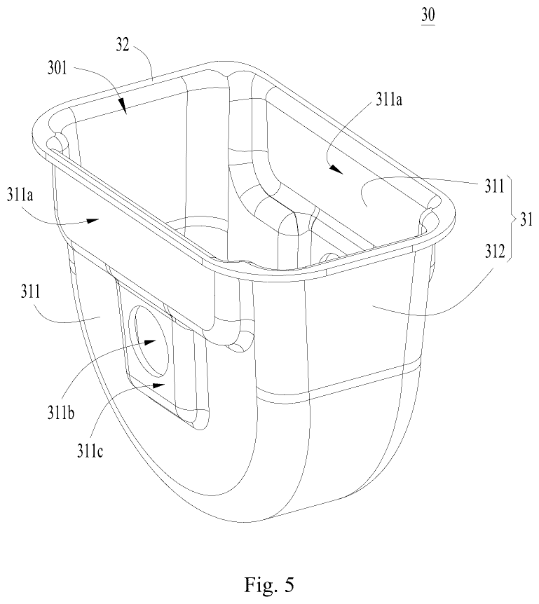

In some embodiments, FIG. 5 illustrates a partial structure of the paper inner holder 30. As shown in FIG. 3 to FIG. 5, the paper inner holder 30 includes a body 31 and an outer flange 32. The body 31 is provided with the second accommodating cavity 301. The outer flange 32 and at least a portion of the body 31 are separately connected to the paper bottom outer box 20 by friction fit.

In the process of loading the paper inner holder 30 into the paper bottom outer box 20, the outer flange 32 of the paper inner holder 30 can play a limiting and guiding role, which is conducive to ensuring the smooth loading of the paper inner holder 30 into the paper bottom outer box 20, reducing the possibility of the paper inner holder 30 getting stuck inside the paper bottom outer box 20 due to positional deviation of the paper inner holder 30, and improving the smoothness and operability of assembly between the paper inner holder 30 and the paper bottom outer box 20.

After the paper inner holder 30 is loaded into the paper bottom outer box 20, the outer flange 32 and at least a portion of the body 31 are separately in contact with the paper bottom outer box 20, and a relatively large contact area can be formed between the paper inner holder 30 and the paper bottom outer box 20, and the paper bottom outer box 20 can limit and constrain the paper inner holder 30 in a plurality of contact areas, to reduce the possibility of position deviation of the paper inner holder 30 inside the paper bottom outer box 20 due to external force.

In some embodiments, a width of the outer flange 32 can range from 0.5 millimeter to 1 millimeter.

In some embodiments, as shown in FIG. 3 to FIG. 5, the paper inner holder 30 includes two first sidewalls 311. In an axial direction of the paper floss bobbin 40, the two first sidewalls 311 are spaced apart. Two ends of the paper floss bobbin 40 are rotatably connected to the two first sidewalls 311. The first sidewall 311 includes a reinforcement portion 311a. The reinforcement portion 311a is connected to the paper bottom outer box 20 by friction fit.

When the floss roll 300 is installed on the paper floss bobbin 40, at least a portion of the floss roll 300 is located between the two first sidewalls 311. In the axial direction of the paper floss bobbin 40, the two first sidewalls 311 can limit and constrain the floss roll 300, to reduce the possibility of positional deviation of the floss roll 300 in the axial direction of the paper floss bobbin 40 when the user pulls the floss roll 300 to rotate.

The first sidewall 311 provided with the reinforcement portion 311a has relatively high structural strength and pressure resistance, which ensures that the overall structure of the paper inner holder 30 has relatively high strength and pressure resistance, and the entire first sidewall 311 or paper inner holder 30 is less prone to deformation and crushing under external force.

After the paper inner holder 30 is loaded into the paper bottom outer box 20, the reinforcement portion 311a of the first sidewall 311 is in contact with the paper bottom outer box 20. The area on the first sidewall 311 except the reinforcement portion 311a may have a gap with the paper bottom outer box 20.

In some embodiments, a portion of the first sidewall 311 protrudes towards the paper bottom outer box 20 to form the reinforcement portion 311a. The reinforcement portion 311a is located on the side of the paper floss bobbin 40 close to the second opening.

The paper inner holder 30 is of a one-piece molded structure. The direct formation of the reinforcement portion 311a on the first sidewall 311 replaces separate processing and then assembly of the first sidewall 311 and the reinforcement portion 311a, which can eliminate the process of separately processing the reinforcement portion 311a and bonding the reinforcement portion 311a to the first sidewall 311 with an adhesive, and can also eliminate the use of the adhesive to improve the environmental friendliness of the box assembly 10.

In one embodiment, a recessed cavity is formed on the first sidewall 311 corresponding to the reinforcement portion 311a. The recessed cavity is in communication with the second accommodating cavity 301.

In some embodiments, as shown in FIG. 3 to FIG. 5, the paper inner holder 30 includes two first sidewalls 311. The first sidewall 311 is provided with a mounting hole 311b. An end of the paper floss bobbin 40 is inserted into the mounting hole 311b. The end of the paper floss bobbin 40 is rotatably connected to the first sidewall 311 by friction fit.

The paper floss bobbin 40 is rotatably connected to the paper inner holder 30 by friction fit only, so an additional connector is not required between the paper floss bobbin 40 and the paper inner holder 30. On the one hand, the quantity of parts of the entire box assembly 10 can be reduced, and the assembly process can be reduced. On the other hand, the paper floss bobbin 40 and the paper inner holder 30 are easy to disassemble and assemble, which is conducive to reducing difficulties in reuse of the box assembly 10 and replacement of the floss roll 300 and improving the usability of the box assembly 10.

The interference fit between the paper floss bobbin 40 and the mounting hole 311b ensures the frictional resistance between the paper floss bobbin 40 and the first sidewall 311 when the user pulls the floss, to maintain moderate tension of the floss during drawing, facilitating the user to slowly and accurately draw the predetermined length of floss, and reducing the possibility of difficult control on the length of the drew floss.

Under the frictional resistance, the paper floss bobbin 40 can rotate slowly relative to the first sidewall 311, which is conducive to improving the tactile sensation of the floss drawing process and enhancing the usage satisfaction of the box assembly 10.

After the floss roll 300 inside the box assembly 10 is used up, the paper inner holder 30 and the paper floss bobbin 40 are removed from the paper bottom outer box 20 by pulling the paper floss bobbin 40. Then, the paper floss bobbin 40 is pulled out from the mounting hole 311b. A new floss roll 300 is reinstalled in the second accommodating cavity 301 of the paper inner holder 30. Next, the paper floss bobbin 40 is inserted into one of the mounting holes 311b, threaded through the central insertion hole of the floss roll 300, and inserted into the other mounting hole 311b, to complete the assembly of the paper floss bobbin 40, the floss roll 300, and the paper inner holder 30.

In some embodiments, the mounting hole 311b may be a through hole or a blind hole.

In some embodiments, the paper floss bobbin 40 may be a paper tube having an outer diameter of 5 millimeters (mm) and a wall thickness of 1.5 millimeters, which facilitates the production of the paper floss bobbin 40.

In some embodiments, as shown in FIG. 5, a portion of the first sidewall 311 protrudes towards the paper bottom outer box 20 to form a protrusion 311c. The protrusion 311c is provided with the mounting hole 311b. There is a gap between the protrusion 311c and the paper bottom outer box 20. There is a gap between the end of the paper floss bobbin 40 and the paper bottom outer box 20.

The first sidewall 311 is provided with the protrusion 311c, which can improve the structural strength and pressure resistance of the first sidewall 311, to improve the overall structural strength and pressure resistance of the paper inner holder 30. The entire first sidewall 311 or paper inner holder 30 is less prone to deformation and crushing under external force.

The paper inner holder 30 is of a one-piece molded structure. The direct formation of the protrusion 311c on the first sidewall 311 replaces separate processing and then assembly of the first sidewall 311 and the protrusion 311c, which can eliminate the process of separately processing the protrusion 311c and bonding the protrusion 311c to the first sidewall 311 with an adhesive, and can also eliminate the use of the adhesive to improve the environmental friendliness of the box assembly 10.

In the process of pressing the paper inner holder 30 into the paper bottom outer box 20 or pulling the paper inner holder 30 out from the paper bottom outer box 20, the protrusion 311c of the first sidewall 311 and the end of the paper floss bobbin 40 are less prone to contact with the paper bottom outer box 20.

In a state that the paper inner holder 30 and the paper floss bobbin 40 are loaded into the paper bottom outer box 20, when the paper floss bobbin 40 rotates relative to the paper inner holder 30, no frictional resistance is produced between the end of the paper floss bobbin 40 and the paper bottom outer box 20, which can reduce the possibility of difficult rotation caused by excessive frictional resistance on the paper floss bobbin 40, and also can reduce the possibility of producing debris due to frequent friction between the end of the rotating paper floss bobbin 40 and the paper bottom outer box 20.

In one embodiment, the reinforcement portion 311a on the first sidewall 311 is located on the side of the protrusion 311c close to the second opening of the paper bottom outer box 20.

In some embodiments, as shown in FIG. 3 to FIG. 5, the paper inner holder 30 includes two first sidewalls 311 and a second sidewall 312. The second sidewall 312 connects the two first sidewalls 311. The first sidewalls 311 and the second sidewall 312 encloses the second accommodating cavity 301. At least a portion of the second sidewall 312 is connected to the paper bottom outer box 20 by friction fit.

The first sidewalls 311 and the second sidewall 312 can be connected and support each other to ensure that the entire paper inner holder 30 has good structural strength and pressure resistance. When the floss roll 300 is installed on the paper floss bobbin 40, the first sidewalls 311 and the second sidewall 312 can protect the floss roll 300, to reduce the possibility of deformation or scattering of the floss roll 300 due to external pressure during the replacement of the floss roll 300.

In one embodiment, sides 100 of the second sidewall 312 are connected to sides 100 of the paper bottom outer box 20 by friction fit. In the process of pressing the paper inner holder 30 into the paper bottom outer box 20 or pulling the paper inner holder 30 out from the paper bottom outer box 20, frictional resistance is produced between the sides 100 of the second sidewall 312 and the sides 100 of the paper bottom outer box 20.

In one embodiment, a bottom 200 of the paper bottom outer box 20 is connected to the sides 100 of the paper bottom outer box 20. The bottom 200 of the paper bottom outer box 20 may be arc-shaped. The bottom 200 of the second sidewall 312 is connected to the side 100 of the second sidewall 312. The bottom 200 of the second sidewall 312 may be arc-shaped. The bottom 200 of the second sidewall 312 matches the bottom 200 of the paper bottom outer box 20 in shape. When the paper inner holder 30 is loaded into the paper bottom outer box 20, the bottom 200 of the second sidewall 312 can be in contact with the bottom 200 of the paper bottom outer box 20.

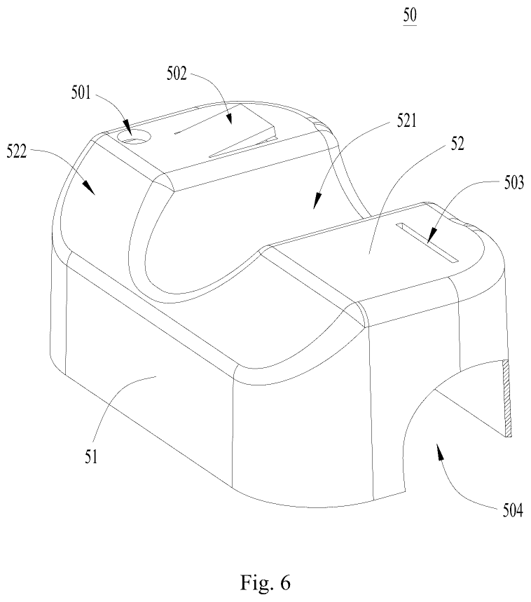

In some embodiments, FIG. 6 illustrates a partial structure of the paper upper holder 50. As shown in FIGS. 3, 4, and 6, the paper upper holder 50 includes a third sidewall 51 and a first top wall 52 connected to each other. The third sidewall 51 and the first top wall 52 enclose a third accommodating cavity 504. The outlet opening 501 and the floss cutter 60 are disposed on the first top wall 52. The outlet opening 501 is in communication with the third accommodating cavity 504. The second accommodating cavity 301 of the paper inner holder 30 is in communication with the third accommodating cavity 504. The second accommodating cavity 301 and the third accommodating cavity 504 can form an accommodating space for accommodating the floss roll 300. At least a portion of the third sidewall 51 is inserted into the second accommodating cavity 301 of the paper inner holder 30. The third sidewall 51 is detachably connected to the paper inner holder 30 by friction fit.

The third sidewall 51 and the first top wall 52 can be connected and support each other to ensure that the entire paper upper holder 50 has good structural strength and pressure resistance. No additional connectors are required between the third sidewall 51 and the paper inner holder 30, which is conducive to reducing the quantity of parts of the entire box assembly 10 and simplifying the assembly process.

When the paper upper holder 50 needs to be separated from the paper inner holder 30, the user can pinch the third sidewall 51 and apply a pull force to the paper upper holder 50 to overcome the frictional resistance between the third sidewall 51 and the paper inner holder 30, to separate the paper upper holder 50 from the paper inner holder 30.

In some embodiments, the paper inner holder 30 is entirely located inside the paper bottom outer box 20. The paper bottom outer box 20 is higher than the second opening of the paper inner holder 30. There is a gap between the second opening of the paper inner holder 30 and the first opening of the paper bottom outer box 20. The third sidewall 51 of the paper upper holder 50 are partially inserted into the paper inner holder 30, partially located inside the paper bottom outer box 20, and partially exposed outside the paper bottom outer box 20.

In some embodiments, the paper upper holder 50 is connected to the paper bottom outer box 20 by friction fit. A portion of the third sidewall 51 is detachably connected to the paper bottom outer box 20 by friction fit. A pull force is applied to the paper upper holder 50 to overcome the frictional resistance between the third sidewall 51 and the paper inner holder 30 and the frictional resistance between the third sidewall 51 and the paper bottom outer box 20, to separate the paper upper holder 50 from the paper inner holder 30.

In some embodiments, as shown in FIG. 4 and FIG. 6, the first top wall 52 has a recess 521. The outlet opening 501 and the floss cutter 60 are disposed on two sides of the recess 521 respectively.

The first top wall 52 is provided with the recess 521, which can improve the structural strength and pressure resistance of the first top wall 52, to improve the overall structural strength and pressure resistance of the paper upper holder 50. The entire first top wall 52 or paper upper holder 50 is less prone to deformation and crushing under external force.

When the floss roll 300 is loaded into the box assembly 10, the user draws a predetermined length of floss and then uses the floss cutter 60 to cut the floss. The floss end formed after cutting the floss can be placed in the recess 521 of the first top wall 52. When the user uses the floss next time, user's fingers (such as thumb and index finger) can enter the recess 521 and easily pinch the floss end and then draw the floss. Therefore, the recess 521 of the first top wall 52 can serve as a finger position, which facilitates the user to pick up the end of the floss, reduces the difficulty of picking up the floss end, and improves the convenience of drawing the floss.

In some embodiments, the bottom of the recess 521 may be arc-shaped.

In some embodiments, as shown in FIG. 6, the first top wall 52 is provided with a floss fixing portion 502. The floss passing through the outlet opening 501 can be fixed on the floss fixing portion 502, to reduce the possibility of knotting and tangling of the unconstrained floss. In one embodiment, there is a gap between the floss fixing portion 502 and the first top wall 52. The floss can be located in the gap between the floss fixing portion 502 and the first top wall 52, and the floss fixing portion 502 presses the floss.

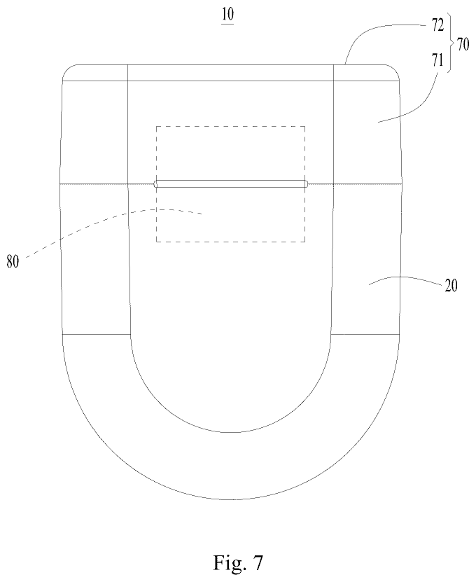

In some embodiments, FIG. 7 illustrates a structure of the box assembly 10. As shown in FIGS. 2, 3, and 7, the paper top cover 70 includes a fourth sidewall 71 and a second top wall 72. The fourth sidewall 71 and the second top wall 72 can enclose a fourth accommodating cavity 701. When the paper top cover 70 is in the closed position, the fourth accommodating cavity 701 of the paper top cover 70 can be in communication with the first accommodating cavity 21 of the paper bottom outer box 20. The fourth accommodating cavity 701 of the paper top cover 70 and the first accommodating cavity 21 of the paper bottom outer box 20 form an accommodating space. The box assembly 10 includes a paper connector 80. The fourth sidewall 71 is connected to the paper bottom outer box 20 by the paper connector 80.

The paper top cover 70 and the paper bottom outer box 20 can be processed separately, and then the paper top cover 70 is connected to the paper bottom outer box 20 by the paper connector 80, which can reduce the processing difficulty of the paper top cover 70 and the paper bottom outer box 20. When the paper top cover 70 is in the open position, because the paper top cover 70 is connected to the paper bottom outer box 20 by the paper connector 80, when the paper top cover 70 is opened, the paper top cover 70 does not need to be removed and placed in another area, which reduces the possibility of losing the paper top cover 70. Meanwhile, the paper top cover 70 can be opened or closed by flipping the paper top cover 70, which is conducive to improving the convenience of operating the paper top cover 70 and improving the usability of the box assembly 10.

The user can operate the box assembly 10 with one hand and apply a flipping torque to the paper top cover 70 to improve the convenience of using the box assembly 10. In one embodiment, the user can hold the paper bottom outer box 20 with palm and apply the flipping torque to the paper top cover 70 with thumb to open or close the paper top cover 70.

In one embodiment, the paper connector 80 may be a piece of paper. The paper may be printed with a text, symbols, patterns, and other information.

In one embodiment, the paper top cover 70 is bonded to the paper connector 80. The paper bottom outer box 20 is bonded to the paper connector 80.

In one embodiment, one end of the paper connector 80 is connected to an inner surface of the fourth sidewall 71. The other end of the paper connector 80 is connected to an inner surface of the paper bottom outer box 20.

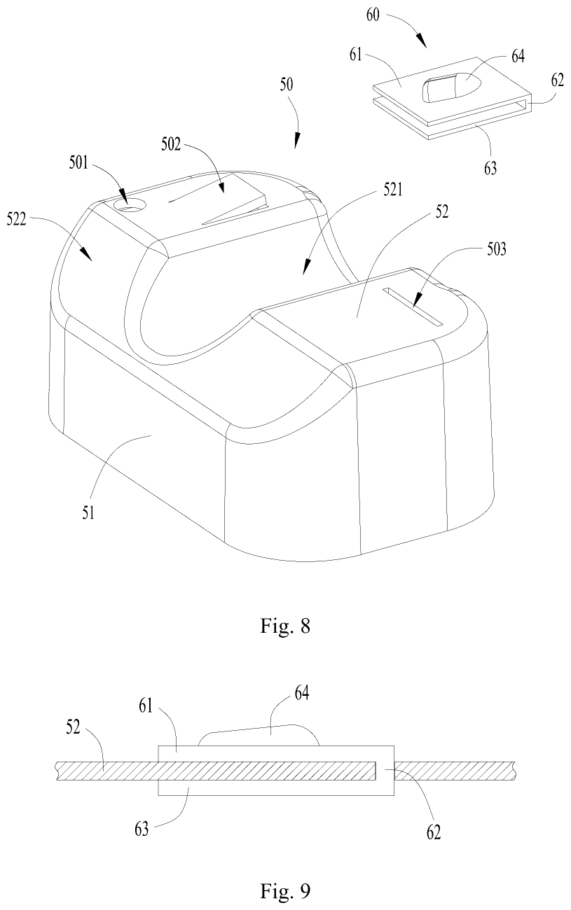

In some embodiments, FIG. 8 illustrates a partially exploded structure of the paper upper holder 50 and the floss cutter 60. As shown in FIG. 2 and FIG. 8, an avoidance slope 522 is provided on the side of the first top wall 52 of the paper upper holder 50 away from the paper connector 80. When the paper top cover 70 is flipped relative to the paper bottom outer box 20, the avoidance slope 522 of the first top wall 52 is used for avoiding the fourth sidewall 71 of the paper top cover 70.

In the flipping process of the paper top cover 70 relative to the paper bottom outer box 20, no positional interference occurs between the first top wall 52 and the paper top cover 70, to reduce the possibility of excessive resistance in the opening or closing process of the paper top cover 70 due to positional interference between the first top wall 52 and the paper top cover 70, improving the convenience of using the lifting box assembly 10, and enabling the user to open or close the paper top cover 70 with one hand.

In some embodiments, FIG. 9 illustrates a partial cross-sectional structure of the box assembly 10. As shown in FIG. 8 and FIG. 9, the paper upper holder 50 has an avoidance opening 503. The floss cutter 60 includes a first clamping piece 61, a connecting piece 62, a second clamping piece 63, and a cutting blade 64. The connecting piece 62 connects the first clamping piece 61 and the second clamping piece 63. The connecting piece 62 is inserted into the avoidance opening 503. The floss cutter 60 is clamped onto the paper upper holder 50 through the first clamping piece 61 and the second clamping piece 63. The first clamping piece 61 is located on an outer side of the paper upper holder 50. The second clamping piece 63 is located on an inner side of the paper upper holder 50. The cutting blade 64 is disposed on the first clamping piece 61. The cutting blade 64 is used for cutting the floss.

The floss cutter 60 is clamped onto the paper upper holder 50 through the first clamping piece 61 and the second clamping piece 63, to connect and fix the floss cutter 60 and the paper upper holder 50, so no additional connector (such as adhesive) is required between the floss cutter 60 and the paper upper holder 50, which is conducive to reducing the quantity of parts of the entire box assembly 10 and improving the environmental friendliness of the box assembly 10.

The assembly process of the floss cutter 60 and the paper upper holder 50 may be as follows: The second clamping piece 63 is allowed to pass through the avoidance opening 503 of the paper upper holder 50, then the floss cutter 60 is pushed, the second clamping piece 63 passes through the avoidance opening 503 and enters the inner side of the paper upper holder 50, and the connecting piece 62 is inserted into the avoidance opening 503. Then, the first clamping piece 61 is released, and the first clamping piece 61, the connecting piece 62, and the second clamping piece 63 restore to their initial state. The first clamping piece 61 and the second clamping piece 63 clamp the paper upper holder 50.

In some embodiments, the first clamping piece 61 and the second clamping piece 63 may be disposed on the same side of the connecting piece 62, and the first clamping piece 61, the connecting piece 62, and the second clamping piece 63 form a U-shaped structure.

In some embodiments, the first top wall 52 of the paper upper holder 50 is provided with the avoidance opening 503. The floss cutter 60 is clamped to the first top wall 52 by clamping the first clamping piece 61 and the second clamping piece 63.

In some embodiments, at least one of the paper bottom outer box 20, the paper inner holder 30, the paper floss bobbin 40, the paper upper holder 50, and the paper top cover 70 is formed by curing raw materials including bamboo pulp and bagasse pulp. A total mass of the bamboo pulp in the raw materials accounts for 35%, and a total mass of the bagasse pulp in the raw materials accounts for 65%.

The bamboo pulp includes bamboo fibers. The bamboo fibers are compact in structure and relative long in fiber length. The bamboo fibers have good mechanical properties such as elastic modulus and tensile strength. The bamboo fibers can improve the tensile strength of processed paper parts, to improve the elasticity of the paper parts. The paper parts including bamboo fibers can deform and are less prone to crack under force. The bagasse pulp includes bagasse. The bagasse has relatively short fibers and good flexibility. The total mass of the bamboo pulp in the raw materials accounts for 35%, and the total mass of the bagasse pulp in the raw materials accounts for 65%, which can ensure that the paper parts have high strength, elasticity, and flexibility.

The paper inner holder 30 is detachably connected to the paper bottom outer box 20 by friction fit. At least one of the paper inner holder 30 and the paper bottom outer box 20 is formed by curing raw materials including bamboo pulp and bagasse pulp, and at least one of the paper inner holder 30 and the paper bottom outer box 20 has elasticity. Therefore, in the process of pressing the paper inner holder 30 into the paper bottom outer box 20, at least one of the paper inner holder 30 and the paper bottom outer box 20 can undergo elastic deformation. After the paper inner holder 30 is pressed into the paper bottom outer box 20, the paper inner holder 30 and the paper bottom outer box 20 can press each other under the action of elastic recovery force to maintain a stable connection state, making it difficult to separate the paper inner holder 30 and the paper bottom outer box 20.

The paper upper holder 50 is detachably connected to the paper inner holder 30 by friction fit. At least one of the paper upper holder 50 and the paper inner holder 30 is formed by curing raw materials including bamboo pulp and bagasse pulp, and at least one of the paper upper holder 50 and the paper inner holder 30 has elasticity. Therefore, in the process of pressing the paper upper holder 50 into the paper inner holder 30, at least one of the paper upper holder 50 and the paper inner holder 30 can undergo elastic deformation. After the paper upper holder 50 is pressed into the paper inner holder 30, the paper upper holder 50 and the paper inner holder 30 can press each other under the action of elastic recovery force to maintain a stable connection state, making it difficult to separate the paper upper holder 50 and the paper inner holder 30.

When the paper top cover 70 is in the closed position, the paper top cover 70 is connected to the paper upper holder 50 by friction fit. At least one of the paper top cover 70 and the paper upper holder 50 is formed by curing raw materials including bamboo pulp and bagasse pulp, and at least one of the paper top cover 70 and the paper upper holder 50 has elasticity. When the paper top cover 70 is in the closed position, at least one of the paper top cover 70 and the paper upper holder 50 can undergo elastic deformation. The paper top cover 70 and the paper upper holder 50 can press each other under the action of elastic recovery force to maintain a stable connection state, making it difficult to accidentally flip and open the paper top cover 70.

The total mass of the bamboo pulp in the raw materials accounts for 35%, and the total mass of the bagasse pulp in the raw materials accounts for 65%, which can ensure that the paper parts processed from the raw materials have good structural strength, pressure resistance and elastic deformation and are less prone to cracking under force.

In some embodiments, the paper bottom outer box 20, the paper inner holder 30, the paper floss bobbin 40, the paper upper holder 50, and the paper top cover 70 are all formed by curing raw materials including bamboo pulp and bagasse pulp.

In some embodiments, the smoothness of an outer surface of the paper bottom outer box 20 is greater than that of an inner surface of the paper bottom outer box 20, and the user can have a good tactile sensation when touching the outer surface of the paper bottom outer box 20. The outer surface of the paper bottom outer box 20 is relatively smoother. The relative rough inner surface of the paper bottom outer box 20 can improve the friction between the paper inner holder 30 and the paper bottom outer box 20.

The smoothness of an outer surface of the paper top cover 70 is greater than that of an inner surface of the paper top cover 70, and the user can have a good tactile sensation when touching the outer surface of the paper top cover 70. The outer surface of the paper top cover 70 is relatively smoother. The relatively rough inner surface of the paper top cover 70 can improve the friction between the paper top cover 70 and the paper upper holder 50.

Although the present application is described with reference to some embodiments, various improvements can be made and equivalents can be substituted for components therein without departing from the scope of the present application. In particular, as long as there is no structural conflict, various features mentioned in the embodiments can be combined in any way. The present application is not limited to the specific embodiments disclosed herein, but includes all embodiments falling within the scope of the claims.

What is claimed is:

1. A box assembly, comprising:
a paper bottom outer box comprising a first accommodating cavity with a first opening;
a paper inner holder comprising a second accommodating cavity with a second opening, wherein the paper inner holder is disposed in the first accommodating cavity, the paper inner holder is detachably connected to the paper bottom outer box by friction fit only, the first opening is disposed corresponding to the second opening, and the second accommodating cavity is for accommodating a floss roll;
a paper floss bobbin rotatably connected to the paper inner holder, wherein the paper floss bobbin is for supporting the floss roll;
a paper upper holder having an outlet opening, wherein the outlet opening is in communication with the second accommodating cavity, the paper upper holder is detachably connected to the paper inner holder by friction fit only, and the paper upper holder is for opening or closing the second opening;
a floss cutter disposed on the paper upper holder, wherein the floss cutter is for cutting a floss led out of the outlet opening; and
a paper top cover connected to the paper bottom outer box and configured to be flipped relative to the paper bottom outer box to switch between an open position and a closed position, wherein in the closed position, the paper top cover closes the first opening and forms an accommodating space with the paper bottom outer box, and the paper top cover is connected to the paper upper holder by friction fit only, and wherein in the open position, the paper top cover opens the first opening, and the outlet opening and the floss cutter are exposed.

2. The box assembly according to claim 1, wherein the paper inner holder comprises a body and an outer flange, the body is provided with the second accommodating cavity, and the outer flange and at least a portion of the body are separately connected to the paper bottom outer box by friction fit only.

3. The box assembly according to claim 1, wherein the paper inner holder comprises two first sidewalls, two ends of the paper floss bobbin are rotatably connected to the two first sidewalls respectively, the first sidewalls each comprise a reinforcement portion, and the reinforcement portion is connected to the paper bottom outer box by friction fit only.

4. The box assembly according to claim 3, wherein a portion of the first sidewall protrudes towards the paper bottom outer box to form the reinforcement portion, and the reinforcement portion is located at a side of the paper floss bobbin close to the second opening.

5. The box assembly according to claim 1, wherein the paper inner holder comprises two first sidewalls, the first sidewalls each are provided with a mounting hole, an end of the paper floss bobbin is inserted into the mounting hole, and the end of the paper floss bobbin is rotatably connected to the first sidewall by friction fit only.

6. The box assembly according to claim 5, wherein a portion of the first sidewall protrudes towards the paper bottom outer box to form a protrusion, the protrusion is provided with the mounting hole, there is a gap between the protrusion and the paper bottom outer box, and there is a gap between the end of the paper floss bobbin and the paper bottom outer box.

7. The box assembly according to claim 1, wherein the paper inner holder comprises two first sidewalls and a second sidewall, the second sidewall connects the two first sidewalls, the first sidewalls and the second sidewall enclose the second accommodating cavity, and at least a portion of the second sidewall is connected to the paper bottom outer box by friction fit only.

8. The box assembly according to claim 1, wherein the paper upper holder comprises a third sidewall and a first top wall connected to each other, the third sidewall and the first top wall enclose a third accommodating cavity, the outlet opening and the floss cutter are disposed on the first top wall, the outlet opening is in communication with the third accommodating cavity, the second accommodating cavity is in communication with the third accommodating cavity, at least a portion of the third sidewall is inserted into the second accommodating cavity, and the third sidewall is detachably connected to the paper inner holder by friction fit only.

9. The box assembly according to claim 8, wherein a portion of the third sidewall is detachably connected to the paper bottom outer box by friction fit only.

10. The box assembly according to claim 8, wherein the first top wall has a recess, and the outlet opening and the floss cutter are disposed on two sides of the recess respectively.

11. The box assembly according to claim 8, wherein the paper top cover comprises a fourth sidewall and a second top wall, the box assembly further comprises a paper connector, and the fourth sidewall is connected to the paper bottom outer box by the paper connector.

12. The box assembly according to claim 11, wherein an avoidance slope is provided on a side of the first top wall away from the paper connector; under a condition that the paper top cover is flipped relative to the paper bottom outer box, the avoidance slope is for avoiding the fourth sidewall.

13. The box assembly according to claim 1, wherein the paper upper holder has an avoidance opening; the floss cutter comprises a first clamping piece, a connecting piece, a second clamping piece, and a cutting blade; the connecting piece connects the first clamping piece and the second clamping piece, the connecting piece is disposed to penetrate through the avoidance opening, the floss cutter is clamped onto the paper upper holder by the first clamping piece and the second clamping piece, the first clamping piece is located on an outer side of the paper upper holder, the second clamping piece is located on an inner side of the paper upper holder, and the cutting blade is disposed on the first clamping piece.

14. The box assembly according to claim 1, wherein at least one of the paper bottom outer box, the paper inner holder, the paper floss bobbin, the paper upper holder, and the paper top cover is formed by curing raw materials comprising bamboo pulp and bagasse pulp, a total mass of the bamboo pulp accounts for 35% of the raw materials, and a total mass of the bagasse pulp accounts for 65% of the raw materials.
